(19) United States
(12) Patent Application Publication
(10) Pub. No.: US 2013/0049667 A1
(43) Pub. Date: Feb. 28, 2013

(54) ADJUSTABLE SPEED FAN

(71) Applicants: LEI LIU, Shenzhen City (CN); XIAO-FENG MA, Shenzhen City (CN)

(72) Inventors: LEI LIU, Shenzhen City (CN); XIAO-FENG MA, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/238,774

(22) Filed: Sep. 21, 2011

(30) Foreign Application Priority Data
Aug. 24, 2011 (CN) 201110247252.0

(51) Int. Cl. H02P 6/08

(52) U.S. Cl. 318/514

(57) ABSTRACT

A fan includes blades, a motor, a bracket fixing the motor, a fan connector, a resistor unit, and a switch unit. The fan connector, the resistor unit, and the switch unit are configured to control power to the motor to adjustably control rotation of the blades. The motor controls the blades to rotate at different speeds through switching the switch unit to adjust the current output to the power terminal of the motor.

### BACKGROUND

1. Technical Field

The present disclosure relates to fans, and particularly, to a fan with adjustable rotation speed.

2. Description of Related Art

Fans are often used to dissipate heat from computers, and rotation speeds of the fans are adjusted by chips of the computers according to the temperature in the computers. During assembling of the computer, testing is performed to check if the installed fans are adequate to dissipate heat. However, during the testing stage, the chip of the computer that will be used to adjust the rotation speed of the fan has not been installed and programmed yet, thus the rotation speed of the fan cannot be adjusted during testing.

### BRIEF DESCRIPTION OF THE DRAWINGS

Many aspects of the present embodiments can be better understood with reference to the following drawings. The components in the drawing are not necessarily drawn to scale, the emphasis instead being placed upon clearly illustrating the principles of the present disclosure. Moreover, in the drawing, all the views are schematic, and like reference numerals designate corresponding parts throughout the several views.

FIG. 1 is an exploded, isometric view of an exemplary embodiment of a fan, wherein the fan includes a rotation speed adjustor.

FIG. 2 is an assembled, plan view of the fan of FIG. 1.

FIG. 3 is a circuit diagram of a first exemplary embodiment of the rotation speed adjustor of FIG. 1.

FIG. 4 is a circuit diagram of a second exemplary embodiment of the rotation speed adjustor of FIG. 1.

### DETAILED DESCRIPTION

The disclosure, including the accompanying drawings in which like references indicate similar elements, is illustrated by way of example and not by way of limitation. It should be noted that references to “an” or “one” embodiment in this disclosure are not necessarily to the same embodiment, and such references mean at least one.

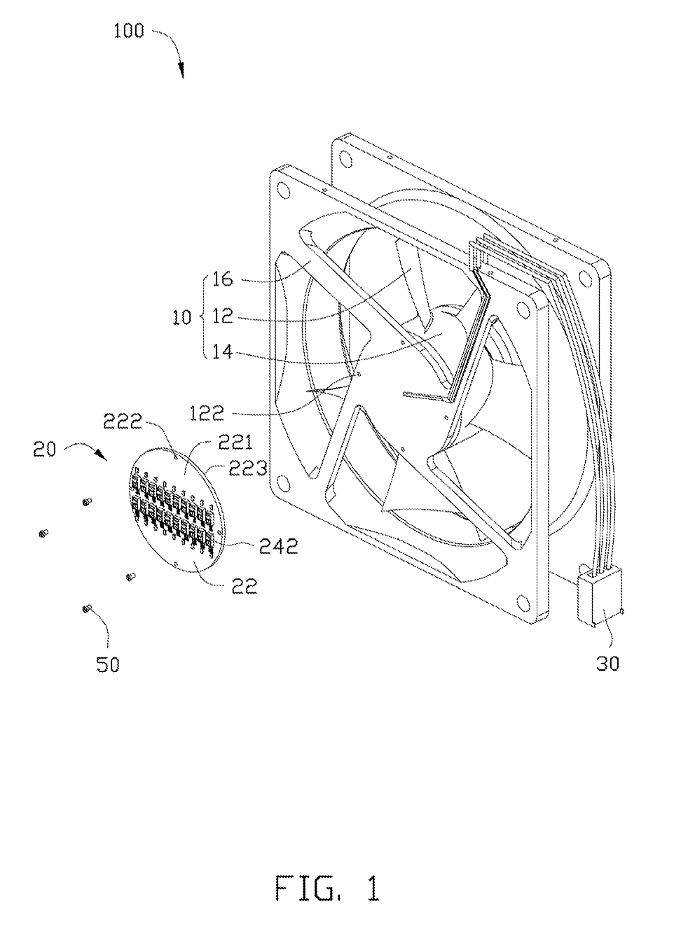

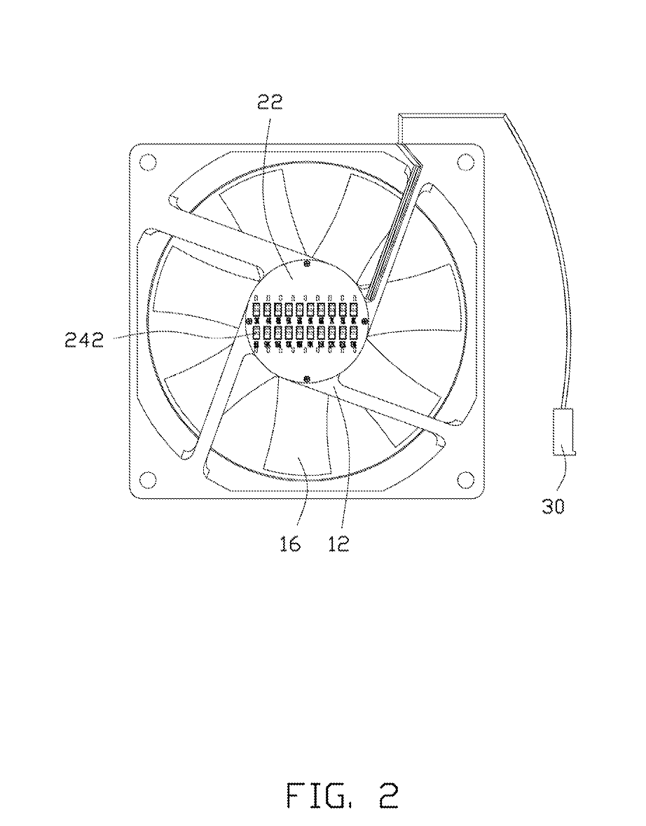

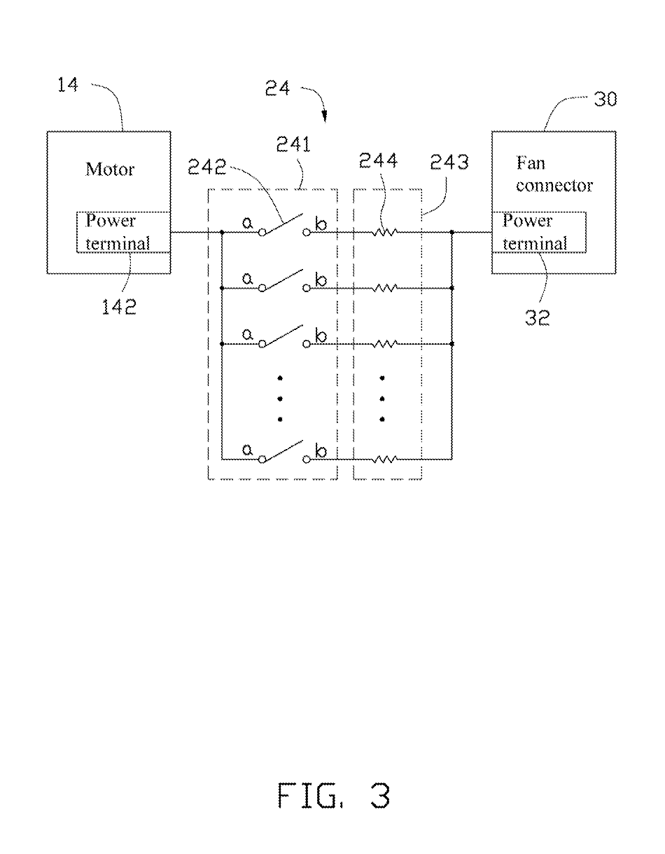

Referring to FIGS. 1 to 3, an embodiment of a fan 100 includes a main body 10, a rotation speed adjustor 20, and a fan connector 30.

The main body 10 includes a motor 14, a bracket 16, and a plurality of blades 12 connected to the motor 14. The motor 14 is fixed in a center position of the bracket 16 to control the blades 12 to rotate. The motor 14 includes a power terminal 142. Four screw holes 122 are defined in the center position of the bracket 16, and arranged along a circle whose center is the center of the bracket 16.

The rotation speed adjustor 20 includes a board 22 and a rotation speed adjusting circuit 24 mounted on the board 22.

The board 22 is substantially round. Four through holes 222, corresponding to the holes 122, are defined in the edge of the board 22.

The rotation speed adjusting circuit 24 includes a switch unit 241 and a resistor unit 243. The switch unit 241 includes a plurality of switches 242. The resistor unit 243 includes a plurality of resistors 244. In a first embodiment, each switch 242 is a single-pole single-throw (SPST) switch. The switches 242 are arranged in two rows on a first surface 221 of the board 22. The resistors 244 are mounted on a second surface 223 of the board 22 opposite to the first surface 221. Resistance of the resistors 244 can be the same or can be different. One switch 242 corresponds to one resistor 244. The resistance of each resistor 244 is labeled on the first surface of the board 22, and located below the corresponding switch 242. A first terminal a of each switch 242 functions as a first terminal of the switch unit 241, and is connected to the power terminal 142. A second terminal b of each switch 242 is connected to a power terminal 32 of the fan connector 30 through the corresponding resistor 244. The second terminals b of the switches 242 together function as a second terminal of the switch unit 241. When the switch 242 is turned on, the resistor 244 connected to the turned on switch 242 is connected between the power terminal 142 of the motor 14 and the power terminal 32 of the fan connector 30. When the switch 242 is turned off, the resistor 244 connected to the turned off switch 242 is disconnected between the power terminal 142 of the motor 14 and the power terminal 32 of the fan connector 30. In assembling the rotation speed adjustor 20, four screws 50 are extended through the corresponding through holes 222 and are engaged in the corresponding screw holes 122 to fix the rotation speed adjustor 20 on the center position of the bracket 16.

When the fan connector 30 is connected to a power source (not shown), the power terminal 32 receives a current and supplies the current to the rotation speed adjustor 20. The resistors 244 connected to the turned on switches 242 are connected between the power terminal 142 of the motor 14 and the power terminal 32 of the fan connector 30. The resistors 244 controls the current to the power terminal 142 of the motor 14 to drive the motor 14 to control the blades 12 to rotate at a first speed. The number of turned on switches 242 can be adjusted to adjust the current to the motor 14. Thus the motor 14 can drive the blades 12 to rotate at different speeds. Therefore, the rotation speed of the blades 12 can be changed by turning the switches 242 on or off to connect different numbers of resistors 244 between the power terminal 142 of the motor 14 and the power terminal 32 of the fan connector 30.

In the embodiment, the board 22 can be fixed on other positions of the bracket 12.

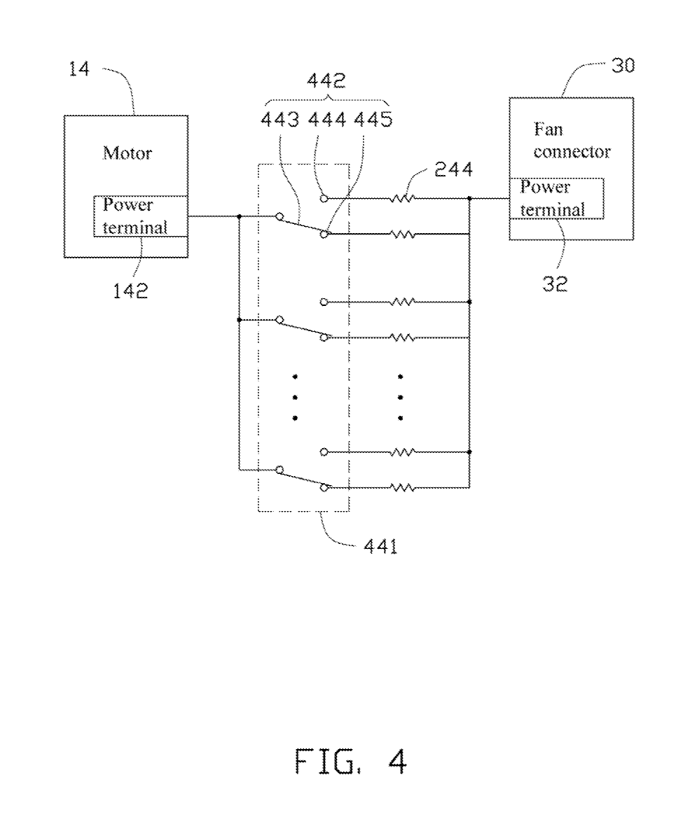

Referring to FIG. 4, a second embodiment of the fan 100 is similar to the first embodiment of the fan 200, except for the switch unit 441. In the second embodiment, the switch unit 441 includes a plurality of switches 442. Each switch 442 is a single-pole double-throw (SPDT) switch 442. One SPDT switch 442 corresponds to two resistors 244. A pole 443 of each SPDT switch 442 functions as a first terminal of the switch unit 441, and is connected to the power terminal of the motor 14. First and second connection portions 444 and 445 of each SPDT switch 442 are connected to the power terminal 32 of the fan connector 30 through two corresponding resistors 244, respectively, to receive a current from the fan connector 30. The first and second connection portions 444 and 445 of the SPDT switches 442 together function as a second terminal of the switch unit 441. The rotation speed of the blades 12 can be changed by switching the poles 443 to connect the first connection portions 444 or the second connection portions 445, thereby connecting different resistors between the power terminal 142 of the motor 14 and the power terminal 32 of the fan connector 30.

Although numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A fan comprising:
a plurality of blades;
a motor to control the plurality of blades to rotate, the motor comprising a first power terminal;
a bracket to fix the motor;
a fan connector to supply a voltage to the motor, the fan comprising a second power terminal;
a resistor unit; and
a switch unit comprising a first terminal connected to the first power terminal, and a second terminal connected to the second power terminal through the resistor unit;
wherein when the fan connector receives a current, the fan connector outputs the current to the resistor unit, the resistor unit controls the current to the first power terminal of the motor through the switch unit to make the motor control the plurality of blades to rotate, the motor controls the plurality of blades to rotate at different speeds through switching the switch unit to adjust the current output to the first power terminal of the motor.

2. The fan of claim 1,wherein the switch unit comprises at least two single-pole single-throw (SPST) switches, the resistor unit comprises at least two resistors, one SPST switch corresponds to one resistor, a first terminal of each SPST switch functions as the first terminal of the switch unit, a second terminal of each SPST switch is connected to the second power terminal of the fan connector through the corresponding resistor, the second terminals of the SPST switches together function as the second terminal of the switch unit, the current output to the first power terminal of the motor is adjusted through controlling a number of the SPST switches that are turned on to connect the resistors connected to the turned on SPST switches to the first power terminal of the motor.

3. The fan of claim 2, further comprising a board, wherein the at least two SPST switches and the at least two resistors are mounted on the board, the board is fixed on the bracket.

4. The fan of claim 3, wherein the at least two SPST switches are mounted on a first surface of the board, and the at least two resistors are mounted on a second surface of the board opposite to the first surface, the resistance of each resistor is labeled on the first surface and located below the corresponding SPST switch.

5. The fan of claim 3, wherein a plurality of screw holes is defined in the bracket, a plurality of through holes corresponding to the screw holes is defined in the board, the board is fixed on the bracket through a plurality of screws extending through the through holes and engaging in the screw holes.

6. The fan of claim 5, wherein the screw holes are defined in a center position of the board.

7. The fan of claim 1, wherein the switch unit comprises at least one single-pole double-throw (SPDT) switch, the resistor unit comprises at least two resistors, one SPDT switch corresponds to two resistors, a pole of each SPDT switch functions as the first terminal of the switch unit, first and second connection portions of each SPDT switch are connected to the second power terminal of the fan connector respectively through the corresponding two resistors, the first and second connection portions of the SPDT switches together function as the second terminal of the switch unit, the current output to the first power terminal of the motor is operable to be changed through switching each SPDT switch to connect the pole to a corresponding one of the first and second connection portions.

8. The fan of claim 7, further comprising a board, wherein the at least one SPDT switch and the at least two resistors are mounted on the board, the board is fixed on the bracket.

9. The fan of claim 8, wherein at least one SPDT switch is mounted on a first surface of the board, the at least two resistors are mounted on a second surface of the board opposite to the first surface, the resistance of each resistor is labeled on the first surface and located below the corresponding SPDT switch.
